(19) United States
(12) Patent Application Publication
(10) Pub. No.: US 2007/0104517 A1
(43) Pub. Date: May 10, 2007

(54) Image forming apparatus and color image forming apparatus

(75) Inventors: Shoko Shimmura, Yokohama-shi (JP); Takashi Hatakeyama, Yokohama-shi (JP); Toshihiro Kasai, Yokohama-shi (JP); Minoru Yoshida, Machida-shi (JP); Takeshi Watanabe, Yokohama-shi (JP); Masashi Takahashi, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/647,246

(22) Filed: Dec. 29, 2006

Related U.S. Application Data
(62) Division of application No. 10/945,440, filed on Sep. 21, 2004.

(51) Int. Cl. G03G 15/09

(52) U.S. Cl. 399/276

(57) ABSTRACT

In a color image forming apparatus of the invention, a developing roller of a developing device includes a magnet roller that is configured such that a developer supply pole, a developer convey pole and a developer release pole are properly arranged and fixed. The developer roller also includes an outer cylindrical roller that is formed of an electrically conductive material such as aluminum. A surface of the cylindrical roller is processed to have irregularities. Using the developing roller, simultaneous development/cleaning is executed. Thus, 100% of toner contributes to image formation, and no waste toner is produced. Post-transfer residual toner on a photoconductor body is efficiently recovered to the developing roller, and occurrence of an image defect such as development memory can be prevented.

The present application is a Divisional of U.S. application Ser. No. 10/945,440, filed Sep. 21, 2004, the entire contents of which is incorporated herein by reference.

### BACKGROUND OF THE INVENTION

1. Field of the Invention

The present invention relates to an image forming apparatus and a color image forming apparatus, which form images using a non-magnetic two-component developer.

2. Description of the Related Art

Various prior-art techniques have been disclosed in connection with cleaning of residual toner on a developing roller of a developing device or on an image carrying body, or in connection with degradation in image quality due to degradation in developer within the developing device.

Jpn. Pat. Appln. KOKAI Publication No. 5-134539, for instance, discloses a technique relating to means for conveying a magnetic single-component toner while sufficiently charging the toner. The means is formed such that the surface of a developing roller is subjected to a knurling process, and formed groove portions are filled with a dielectric so that dielectric areas and electrically conductive areas are distributed over the surface of the developing roller.

In this technique, however, the magnetic single-component toner is used, and a non-magnetic two-component developer is not used.

Jpn. Pat. Appln. KOKAI Publication No. 2001-166556 discloses a technique wherein a cleanerless process is adopted in a tandem-type color laser printer using a non-magnetic single-component developer system. In the case where the developer is composed of a single component, the developing electrode can be put in contact, or situated very close to, residual toner remaining on the image carrying body. Thus, the cleaner process can be realized relatively easily.

However, because of the close positioning of the electrode, the value of development γ is high and the tone characteristics are poor. In addition, in order to uniformly charge toner particles, a charging member, which is a structural component in the developing device, is, in general cases, put in frictional contact with the toner. Due to abrasion degradation of the charging member, defective charging or stripe-like image non-uniformity tends to occur. It is difficult to obtain high-quality images over a long period of time.

Jpn. Pat. Appln. KOKAI Publication No. 2001-194908 discloses a technique wherein post-transfer residual toner is once recovered by a cleaning member, the recovered toner is conveyed to a developing device along a conveyance path, the toner is then brought into the developing device from a predetermined position, and a developer is recovered from a specified position relative to this predetermined position.

In the case of this recycling scheme, however, the post-transfer residual toner is put into the developing device after storing more than a predetermined quantity of post-transfer residual toner that can be conveyed. Consequently, degraded toner, paper dust, or other dust and impurities may non-uniformly be present in the developing device, leading to image defects.

### BRIEF SUMMARY OF THE INVENTION

The object of an aspect of the present invention is to provide an image forming apparatus and a color image forming apparatus, which use a non-magnetic two-component developer and can maintain high image quality by enhancing cleaning efficiency and maintain, even if the developer deteriorates, high image quality by securing a developing conveyance force.

According to an aspect of the present invention, there is provided an image forming apparatus using a two-component developer that is composed of at least non-magnetic color particles and magnetic particles, the apparatus comprising: an image carrying body that carries an electrostatic latent image on a surface thereof; a developer carrying body that is disposed at a position facing the image carrying body and has irregularities on a surface thereof; developing means for developing the electrostatic latent image, which is carried on the image carrying body, with the two-component developer, using the developer carrying body; and control means for executing a control to move the developer carrying body and the image carrying body at different circumferential speeds.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that shows the structure of a control system of a color image forming apparatus according to an embodiment of the present invention;

FIG. 2 is a cross-sectional view that schematically shows the structure of an image forming unit in the color image forming apparatus;

FIG. 3 shows a cross section of a developing roller serving as a developer carrying body;

FIG. 4 shows an example of the cross section of irregularities on the developing roller;

FIG. 5 shows an example of the cross section of irregularities on the developing roller;

FIG. 6 shows an example of the cross section of irregularities on the developing roller;

FIG. 7 shows an example of the cross section of irregularities on the developing roller;

FIG. 8 shows an example of a surface shape of an outer cylindrical roller of the developing roller;

FIG. 9 shows an example of the surface shape of the outer cylindrical roller of the developing roller;

FIG. 10 shows an example of the surface shape of the outer cylindrical roller of the developing roller;

FIG. 11 shows an example of the surface shape of the outer cylindrical roller of the developing roller;

FIG. 12 is a graph showing a relationship between the angle of grooves formed on the developing roller surface and the effects;

FIG. 13 shows experimental results relating to carrier gain sizes;

FIG. 14 schematically shows the structure of an intermediate-transfer type color image forming apparatus according to a fifth embodiment of the invention;

FIG. 15 is a graph showing a post-transfer residual ratio and a reverse transfer ratio in relation to transfer conditions;

FIG. 16 schematically shows the structure of a direct-transfer type color image forming apparatus according to the fifth embodiment of the invention;

FIG. 17 is a graph showing a comparison of developer characteristics;

FIG. 18 shows an example of the structure of a developing device that adopts an occasional small-amount developer replacement method;

FIG. 19 shows an example of the structure of the occasional small-amount developer replacement type developing device; and

FIG. 20 shows a life state (number of prints) of image density in a case where the developing roller in the occasional small-amount developer replacement type developing device is used.

### DETAILED DESCRIPTION OF THE INVENTION

Embodiments of the present invention will now be described with reference to the accompanying drawings.

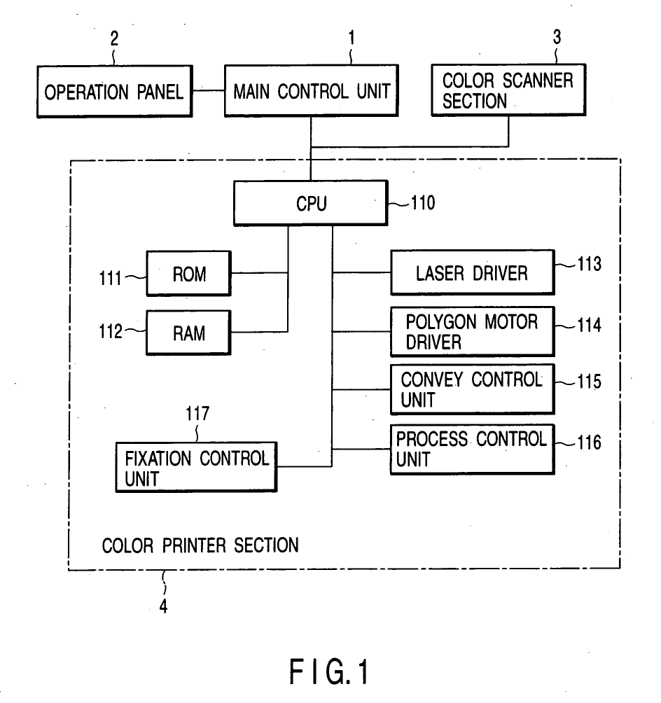

FIG. 1 shows the structure of a control system of a color image forming apparatus according to an embodiment of the present invention. The image forming apparatus comprises a main control unit 1 for executing an overall control, an operation panel 2 for executing various settings, a color scanner section 3 serving as image reading means for reading a color image on an original, and a color printer section 4 serving as image forming means for forming an image.

The color printer section 4 comprises a CPU 110 for executing an overall control; a ROM 111 that stores a control program, etc.; a RAM 112 for storing data; a laser driver 113 that drives a semiconductor laser of a laser optical system (not shown); a polygon motor driver 114 that drives a polygon motor (not shown); a convey control unit 115 that controls conveyance of paper serving as a transfer medium; a process control unit 116 that controls processes of charging, development and transfer using a charging device, a developing roller and a transfer device (all not shown); and a fixation control unit 117 that controls a fixing device (not shown).

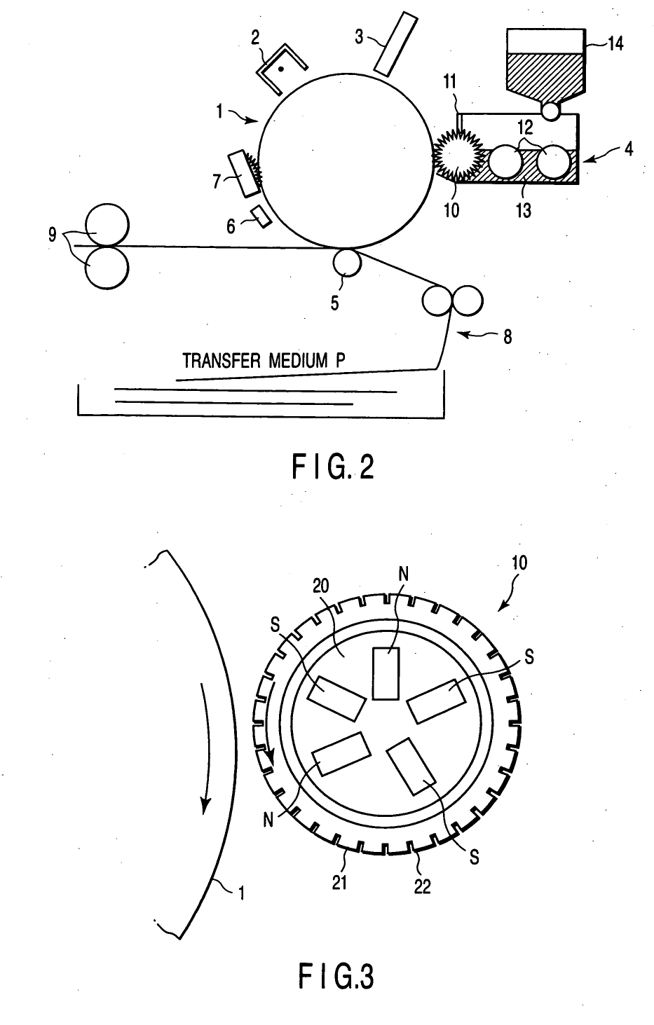

FIG. 2 is a cross-sectional view that schematically shows the structure of an image forming unit in the color image forming apparatus.

The image forming unit comprises a photoconductor body 1, a charging device 2, an exposure device 3, a developing device 4, a transfer roller 5, a charge erase lamp 6 and a memory disturbing brush 7.

The developing device 4 comprises a developing roller (magnetic brush) 10 including a magnet roller, a layer restriction member 11, developer stirring augers 12, a developer container 13, and a replenishing developer hopper 14.

A transfer medium P is fed by a paper feed device 8. A toner on the photoconductor body 1 is transferred to the transfer medium P by the transfer roller 5, and the transferred toner is fixed by a fixing device 9.

The present color image forming apparatus adopts an electrophotographic two-component development system.

The toner has a conventional composition including a binder resin (polyester resin, styrene-acryl resin, etc.), a coloring agent (a publicly known pigment or dye, such as carbon black, condensation polycyclic pigment, azoic pigment, phthalocyanine pigment, or inorganic pigment), a wax serving as a fixation adjuvant, a charge control agent (CCA), and fluidity improving inorganic particles (silica, etc.). The toner is formed by a pulverizing process or a chemical process.

The carrier is a magnetic carrier such as ferrite, magnetite, iron oxide, or resin particles mixed with magnetic powder. Part or the entirety of the surface of the carrier may be coated with resin.

Other modifications may be made without departing from the spirit of the invention.

The photoconductor body 1 is a conventional electrostatic latent image carrying body (belt, roller, etc.) that is formed of positively or negatively charged OPC, amorphous silicon, etc. A charge generating layer, a charge transport layer and a protection layer may be laminated, or a single layer that performs plural functions may be used.

The charging device 2 may be a publicly known charger device such as a corona charger (a charger wire, a comb-teeth charger, a scorotron, etc.), a contact charger roller, a non-contact charger roller, or a solid charger. The charging device 2 uniformly charges the photoconductor body 1 with a desired potential.

The exposure device 3 forms an electrostatic latent image on the photoconductor body 1 using exposing means such as a laser or an LED.

The developing device 4 executes magnetic brush development by conveying a two-component developer with use of the developing roller 10. Thereby, the electrostatic latent image on the photoconductor body 1 is supplied with charged toner and developed into a visible toner image. The developing roller 10 is supplied with a development bias (DC or DC+AC) for generating an electric field that adheres the toner to the electrostatic latent image.

The transfer device 5 is transfer means for transferring the toner image to the transfer medium P such as paper, which is being fed, using a conventional transfer system such as a contact roller, a corona charger, a contact blade, etc.

The transfer medium P is separated from the photoconductor body 1 and conveyed to the fixing device 9. The toner image on the transfer medium P is fixed by a conventional heating/pressing fixation system such as a heating roller, and the transfer medium P with the fixed image is discharged to the outside of the apparatus.

After the toner image is transferred to the transfer medium P, the post-transfer residual toner remaining on the photoconductor body 1 is subjected to the next image forming steps of charge erasure, charging and exposure, and conveyed once again to the development area. The toner remaining on the non-image part is recovered into the developing device 4 by the magnetic brush (developing roller 10).

A memory disturbing member may be disposed before or after the stage of charge erasure.

In addition, in order to once recover the residual toner into the developing device 4, a temporary recover member that re-supplies toner onto the photoconductor body 1 may be provided.

The memory disturbing member and the temporary recover member may be supplied with a positive and/or negative voltage in order to efficiently implement their functions.

On the other hand, the replenishing developer hopper 14 of the developing device 4 contains 100 g to 700 g of a two-component developer that is composed of a carrier and a toner. The two-component developer in the developing device 4 is conveyed to the developing roller 10 by the developer stirring augers 12. The two-component developer in the developing device 4 loses part of the toner by the development, and is then released from the developing roller 10 at the position of the release pole of the magnet roller. Thus, the developer is brought back into the developer container 13 by the stirring augers 12.

The surface of the developing roller 10 in this embodiment is provided with irregularities. The developing roller 10 and photoconductor body 1 move (rotate) at different circumferential speeds at their mutually opposed position. The CPU 110 controls the rotations of the developing roller 10 and photoconductor body 1 through the process control unit 116.

The developer container 13 is equipped with a publicly known toner concentration sensor. When the concentration sensor detects a decrease in amount of toner, the CPU 110 executes a control to deliver a replenishment signal to the replenishing developer hopper 14 and to replenish new toner.

Alternatively, on the basis of the cumulative calculation of print data and/or the detection of the amount of developer toner on the photoconductor body 1, the toner consumption may be estimated. In accordance with the estimation result, the new toner may be replenished.

Both means of the toner concentration sensor output and the estimated toner consumption may be used.

FIG. 3 shows a cross section of the developing roller 10 that serves as the developer carrying body.

The developing roller 10 includes a magnet roller 20 that is configured such that a developer supply pole, a developer convey pole and a developer release pole are properly arranged and fixed. An outer cylindrical roller 21 is formed of an electrically conductive material such as aluminum. The developing roller 10 carries a developer and rotates to convey the developer to the development area.

The surface of the developing roller 10 has irregularities 22 according to the present invention.

FIG. 4 shows an example of the cross section of the irregularities 22 of the developing roller 10 shown in FIG. 3. In reality, the cross-sectional shape of the irregularities 22 is curved since the irregularities 22 are formed on the circumferential surface of the roller. For easier understanding, the cross-sectional shape is depicted in a linear form. The groove pitch is a 1/a cycle, the groove depth is b, and the groove width is c.

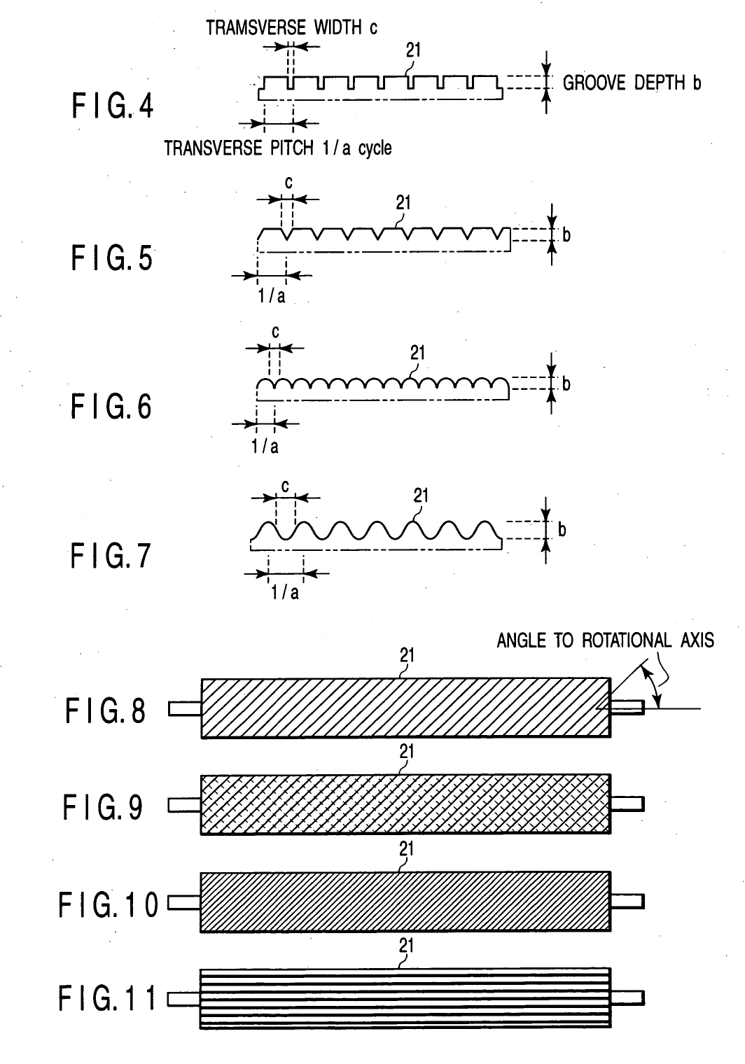

FIG. 5, like FIG. 4, shows another example of the cross section of the irregularities 22, wherein grooves are V-shaped. The groove pitch is a 1/a cycle, the groove depth is b, and the groove width is c.

FIG. 6, like FIG. 4, shows another example of the cross section of the irregularities 22, wherein ridges between grooves are curved. The groove pitch is a 1/a cycle, the groove depth is b, and the groove width is c.

FIG. 7, like FIG. 4, shows another example of the cross section of the irregularities 22, wherein grooves and ridges are formed in a wavy shape. The groove pitch is a 1/a cycle, the groove depth is b, and the groove width is c.

FIG. 8 shows an example of the surface shape of the outer cylindrical roller 21 of the developing roller 10. In this example, grooves are formed with an angle to the rotational axis.

FIG. 9 shows another example of the surface shape of the outer cylindrical roller 21 of the developing roller 10. In this example, grooves are diagonally formed with an angle to the rotational axis.

FIG. 10 shows another example of the surface shape of the outer cylindrical roller 21 of the developing roller 10. In this example, grooves are formed with an angle to the rotational axis with a smaller groove pitch than in FIG. 8.

FIG. 11 shows another example of the surface shape of the outer cylindrical roller 21 of the developing roller 10. In this example, grooves are formed in parallel to the rotational axis.

A first embodiment of the invention with the above-described structure will now be described.

Toner was kneaded, pulverized and classified with a ratio of 91 wt % of polyester resin, 4 wt % of rice wax and 5 wt % of carbon black. Thus, toner particles with a volume mean grain size of 8 μm were obtained. The resultant was combined with external additive of silica and CCA. The developer was formed by mixing 7 wt. % of the toner with 93 wt. % of carrier with a volume mean grain size of 50 μm, which is composed of spherical ferrite particles that are surface-coated with silicone resin.

The outer periphery of the developing roller 10 is provided with the cylindrical roller 21 that is formed of aluminum. The surface of the cylindrical roller 21 is provided with irregularities at random. A height difference between a groove part and a ridge part of the irregularities is 200 μm on average. The distance between adjacent ridges is 400 to 800 μm.

The gap between the layer restriction member 11, which is disposed in the developing device 4, and the developing roller 10 is set at 500 μm. The gap between the developing roller 10 and photoconductor body 1 is set at 650 μm. The surface of the photoconductor body 1 is uniformly charged at −500 V by the charging device 2. An electrostatic latent image is formed on the photoconductor body 1 using the exposure device 3 with 600 dpi. The developing device 10 is supplied with a development bias of DC −280 V.

The surface potential of the photoconductor body 1, the development bias, etc. are varied by a process control upon detection of the environment, time-dependent variation of developer, etc. The photoconductor body 1 and the developing roller 10 rotate in the same direction (with) at the mutually opposed position, with the process speed of the photoconductor body 1 being 130 mm/sec and with the circumferential speed ratio of 2.0 of the developing roller 10 to the photoconductor body 1.

In the development region that is formed by the photoconductor body 1 and developing roller 10, the electrostatic latent image is developed by the toner. In the transfer region that are formed by the photoconductor body 1 and transfer roller 5, a transfer bias is applied to the transfer roller 5 and thus the toner image is transferred to the transfer medium P.

Part of the toner on the photoconductor body 1 is not transferred and remains as residual toner. The residual toner is disturbed by the memory disturbing brush 7 that is disposed on the downstream side of the charge erase unit. Subsequently, the residual toner is subjected to charging and exposure, and re-enters the development area.

At this time, the post-transfer residual toner that adheres to a non-image part of a newly formed electrostatic latent image is stimulated by the force of an electric field, which is generated by the surface potential of the photoconductor body 1 and the development bias and is minutely varied by the irregularities on the surface of the developing roller 10. The post-transfer residual toner is mechanically removed by the magnetic brush and recovered into the developing roller side by the force of the electric field acting toward the developing roller 10.

The post-transfer residual toner, which adheres to an image part of the electrostatic latent image, remains on the photoconductor body 1, and new toner is developed on the photoconductor body 1. Thus, the resultant toner image is conveyed to the transfer region.

As has been described above, according to the first embodiment, the simultaneous development/cleaning is executed by the developing roller. Thereby, 100% of toner contributes to image formation, and no waste toner is produced. In the meantime, the transfer efficiency at the transfer region is about 93%, and the ordinary system using a cleaning device produces waste toner that corresponds to 7% of the entire toner.

With the structure of the present embodiment, the post-transfer residual toner is efficiently recovered by the developing roller, and occurrence of an image defect such as development memory can be prevented.

Next, a second embodiment is described.

The random irregularities, which are formed on the surface of the developing roller 10, as in the first embodiment, are weak in structure. The ridge portions may be collapsed by weak shock or may gradually be abraded over the life.

In the second embodiment, a development roller 10, as shown in FIG. 11, is subjected to a knurling process (fine-groove forming process) in a direction parallel to the rotational axis. This developing roller 10 has a groove depth of 200 μm, a width of 150 μm and a pitch of 850 μm.

Using the developing roller 10, image formation was performed in the same method as in the first embodiment. Post-transfer residual toner was efficiently recovered by the developing roller 10, and no image defect, such as memory, occurred.

A life test was conducted. No memory occurred due to defective recovery of post-transfer residual toner, even when printing was effected on 100,000 paper sheets.

Next, a third embodiment is described.

In the third embodiment, the knurling process was conducted on a developing roller 10, as shown in FIG. 8, with an inclination of 20° relative to the rotational axis of the developing roller 10.

In the case of the developing roller of the second embodiment, which has the grooves parallel to the rotational axis, a slight stripe-like density variation occurred in a uniform large-area half-tone image. In the third embodiment, however, with the inclination of the grooves, a uniform density was obtained in the large-area solid image.

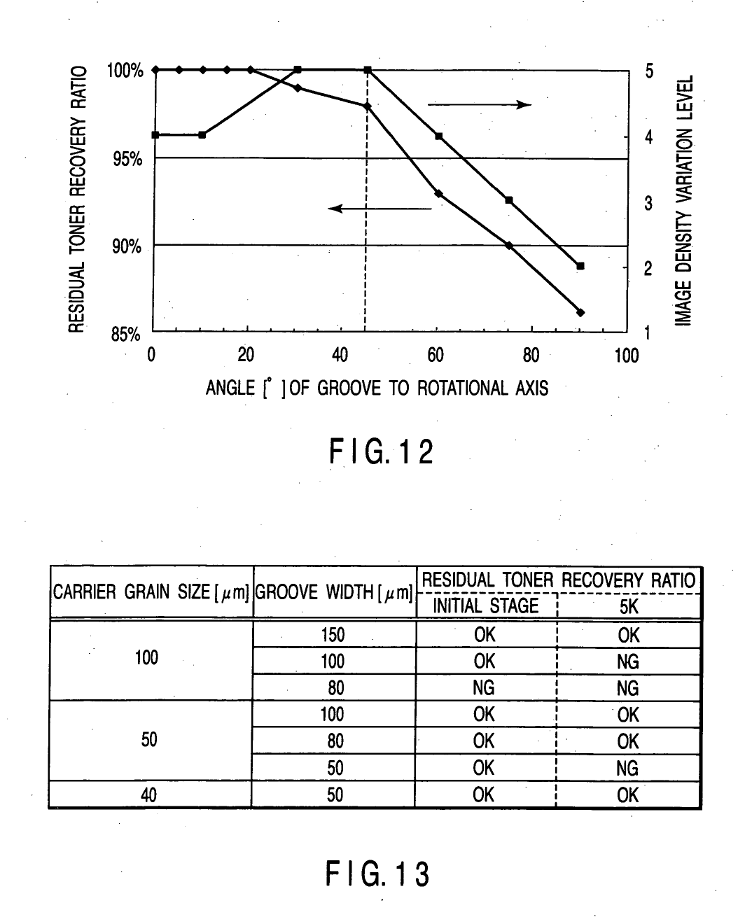

FIG. 12 is a graph showing the angle of grooves relative to the rotational axis, a visual evaluation result of the image density variation in the solid part, and a measurement result of the recovery efficiency of post-transfer residual toner in the development region.

When an image density variation occurred, a magenta image was examined with respect to a high density range of about 1.0 (Macbeth densitometer, SPI filter) at which visual sensitivity is high.

In the visual evaluation, variation levels were expressed by points as follows.

Variation level 5 means that no density variation is perceived.

Variation level 4 means that a slight density variation is perceived, and it falls within a tolerable range.

Variation level 3 means that there is a density variation.

Variation level 2 means that there is a density variation, which is not tolerable.

Variation level 1 means that there is a great density variation.

If the angle of grooves to the rotational axis exceeds 45° and the recovery efficiency falls to 95% or below, a positive memory occurs. The range of angles of about 30 to 45° is optimal with respect to the image density variation, but the range of angles of 0 to 60° is tolerable. From the result, it is determined that the range of angles of 0 to 45° is optimal.

Next, a fourth embodiment is described.

In the fourth embodiment, magnetic particles, which are formed by coating ferrite particles with a mean grain size of 100 μm with resin, were used as carrier particles. The developing roller surface was subjected to a knurling process with an inclination of 30° to the rotational axis of the developing roller 10. The groove width was set at 100 μm, the groove depth was set at 100 μm, and the pitch of irregularities was set at 900 μm.

As a result, with repetition of printing operations, carrier particles that are caught in the grooves were hardened, the recovery efficiency of pot-transfer residual toner decreased, and image memory occurred. Similarly, in a case where the groove width was set to be less than 100 μm, the post-transfer residual toner could not completely be recovered by the developing roller 10.

However, if the groove width was set at 150 μm or more, simultaneous cleaning was successfully executed. In a case where carrier particles with a mean grain size of 50 μm were used, there was no problem even if the groove width was 100 μm.

FIG. 13 shows experimental results relating to carrier grain sizes.

If the carrier grain size is less than the groove width, the toner recovery efficiency was good. In the case where the carrier grain size is equal to the groove width, the toner recovery efficiency was good at the initial stage but deteriorated after the life of 5000 (5K) hours, resulting in formation of image memory. In the case where the carrier grain size is greater than the groove width, image memory occurred from the beginning.

It is understood, from the above, that the groove width should preferably be greater than the mean grain size of carrier particles.

If the groove width is too great, it is not possible to obtain the effect that the electric field can minutely be varied, and the toner cannot efficiently be recovered. Therefore, the width of the groove, which is perpendicular to the rotational axis, should desirably be approximately c/n≦2 mm, where n is the ratio in circumferential speed of the developing roller 10 to the photoconductor body 1.

Next, a fifth embodiment is described.

The fifth embodiment relates to a color image forming apparatus that includes a number of image forming units each comprising at least a photoconductor body, charging means, exposure means, developing means and transfer means. The number of image forming units corresponds to the number of colors. The image forming units are juxtaposed along an intermediate transfer drum (or belt) or a transfer medium convey path.

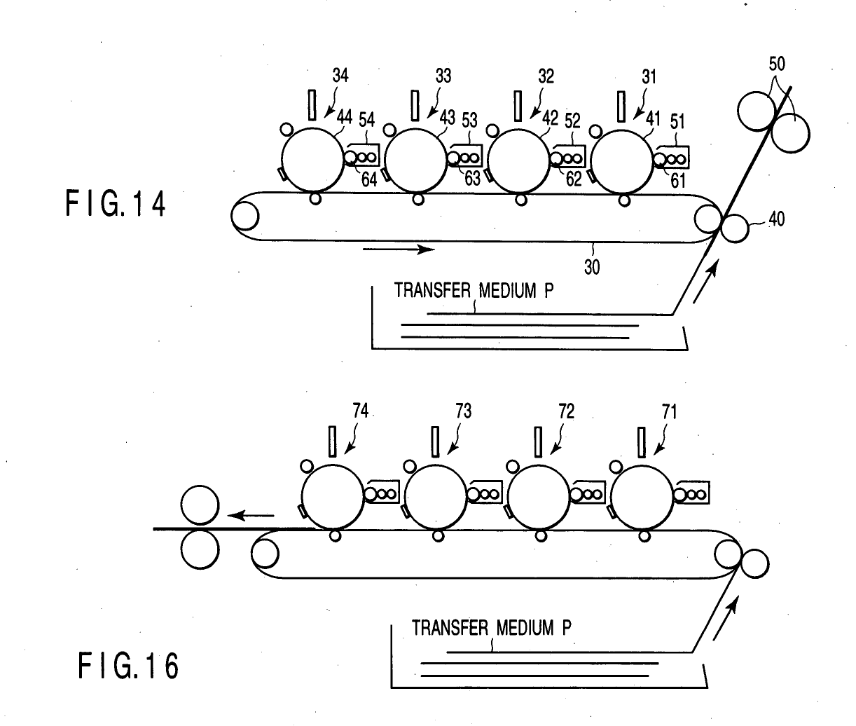

FIG. 14 schematically shows the structure of an intermediate-transfer type color image forming apparatus according to the fifth embodiment. The color image forming apparatus is a full-color printing apparatus having four process colors of cyan, magenta, yellow and black. A first image forming unit 31 transfers yellow, a second image forming unit 32 transfers magenta, a third image forming unit 33 transfers cyan, and a fourth image forming unit 34 transfers black.

The first image forming unit 31 transfers a yellow toner image from a photoconductor body 41 to an intermediate transfer member 30. In this case, the photoconductor body 41, with a post-transfer residual toner adhering to the surface thereof, proceeds to an electrostatic latent image forming step for the next image printing operation.

Prior to a charging stage, there may be provided a memory disturbing member that disturbs an image structure of post-transfer residual toner to make image memory less possible; a temporary recovery member that once recovers toner and re-supplies the toner to photoconductor body at a predetermined timing; a charging member that adjusts a charge amount of the post-transfer residual toner; and a member for removing paper dust or other impurity mixtures. A single member may implement the functions of these members. Alternatively, the photoconductor body charging member may also have part or all of these functions.

In the state in which post-transfer residual toner remains on the photoconductor body 41, an electrostatic latent image for the next image formation is formed on the photoconductor body 41. The electrostatic latent image is developed at a development region in the following manner. While post-transfer residual toner at an image part on the photoconductor body 41 is left as such, new toner for development is additionally supplied to make up for a deficiency in toner. On the other hand, post-transfer residual toner at a non-image part on the photoconductor body 41 is put in contact with the magnetic brush in the developing device 51 and thus attracted to the developing roller 61 side. With rotation of the developing roller 61, the toner at the non-image part is recovered into the developing device 51.

Then, the second image forming unit 32 transfers a magenta toner image from a photoconductor body 42 to the intermediate transfer member 30 on which the yellow toner image is formed in the non-fixed state. In this case, the transfer efficiency of the magenta toner is not 100%, and post-transfer residual toner remains on the photoconductor body 42. In addition, when the yellow toner on the intermediate transfer member 30 comes in contact with the non-image part on the photoconductor body 42, part of the yellow toner is attracted by, and reversely transferred to, the photoconductor body 42.

Normally, in the case of a single-color image printing apparatus, a transfer condition for obtaining a maximum transfer efficiency is set in order to minimize the possibility of occurrence of image memory.

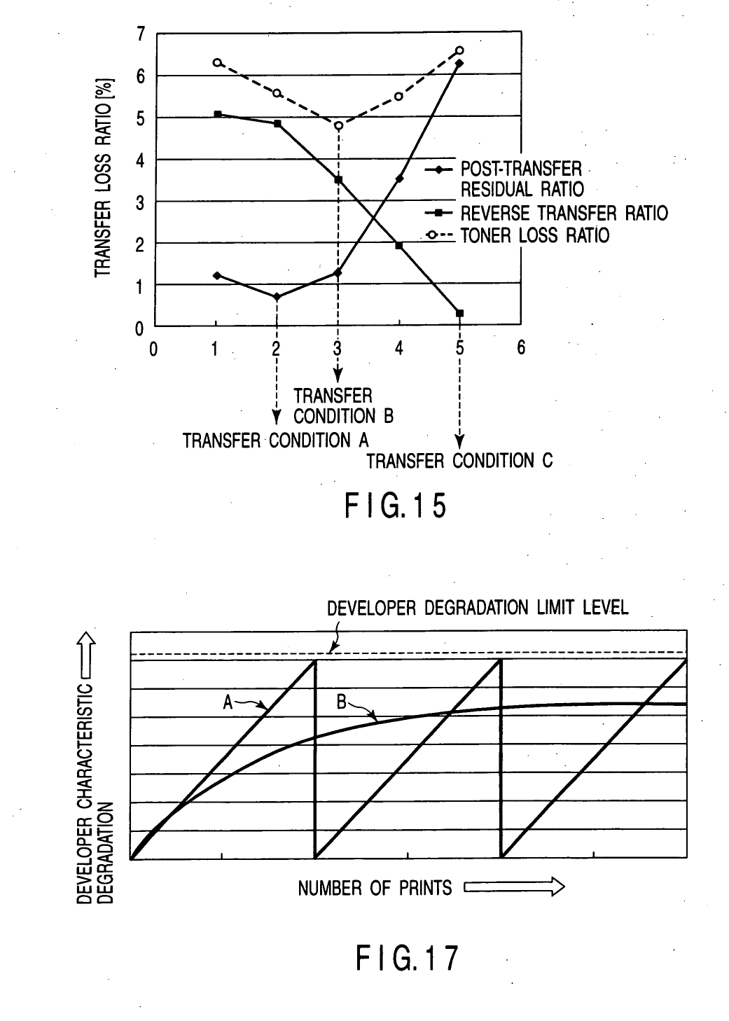

FIG. 15 is a graph showing a post-transfer residual ratio and a reverse transfer ratio in relation to transfer conditions.

In FIG. 15, a transfer condition A can achieve a maximum transfer efficiency.

In the case of a color image forming apparatus that includes a cleaning member and recovers and discharges post-transfer residual toner, a transfer condition, which can achieve a minimum loss ratio by summing up a toner loss due to post-transfer residual and a toner loss due to reverse transfer, is selected. In FIG. 15, a transfer condition B meets this condition.

In the case of a cleanerless color image forming apparatus, however, if a color toner in a preceding process step is reversely transferred, the reverse-transfer toner, whose color is different from that of post-transfer residual toner, is also recovered into the developing device. This causes mixing of color toners, and the color of an output image cannot be controlled. Therefore, a transfer condition C, which causes no reverse transfer, is selected in this case.

In this way, cyan and black toners are transferred to the intermediate transfer member 30 in an overlapping fashion. The toner image on the intermediate transfer member 30 is transferred to a transfer medium P, such as paper, by second transfer means 40. At last, in a fixing device 50, fixing means fixes the toner image on the transfer medium P, such as paper, by heat and/or pressure, and the transfer medium P is output.

For example, when the transfer condition C in FIG. 15 is selected, reverse transfer hardly occurs, but the post-transfer residual ratio is about 6.5% in this embodiment, which is considerably higher than in the transfer condition A (0.8%) or transfer condition B (1.3%). Consequently, in the case of a prior-art developing device having a developing roller with no irregularities, simultaneous development/recovery is not sufficiently executed by the developing roller, and an image defect such as image memory would easily occur.

In the present embodiment, however, the developing roller surface is provided with irregularities. Thereby, post-transfer residual toner was fully recovered and no image defect occurred. Such irregularities were formed with fine grooves that are substantially parallel to the rotational axis of the developing roller. No deterioration occurred in the toner recovery efficiency due to life. Furthermore, fine grooves were formed with an inclination of not less than 0° and not greater than 45°, relative to the rotational axis. Fine non-uniformity in density on the solid image part was eliminated, and the image quality was enhanced.

FIG. 16 schematically shows the structure of a direct-transfer type color image forming apparatus according to the fifth embodiment. A first image forming unit 71 directly transfers yellow to a transfer medium P, a second image forming unit 72 directly transfers magenta to the transfer medium P, a third image forming unit 73 directly transfers cyan to the transfer medium P, and a fourth image forming unit 74 directly transfers black to the transfer medium P. The other structure is the same as shown in FIG. 14, and the same advantageous effects are obtained as in FIG. 14.

Next, a sixth embodiment is described.

The sixth embodiment relates to a developing device 4 that adopts an occasional small-amount developer replacement method.

The developing device 4 includes at least a developing roller 10, developer stirring augers 12, and a developer amount restriction member that restricts the amount of developer conveyed by the developing roller. The developing device 4 stores a two-component developer that is composed of a non-magnetic toner and a magnetic carrier. Additionally, the developing device 4 may include a publicly known density sensor, such as a magnetic permeability sensor or an optical sensor, which detects a toner content in the developer. Furthermore, the developing device 4 may include a mechanism for estimating a toner content in the developer by detecting, e.g. an image print ratio, or a development amount on the photoconductor body.

The developing device 4 includes a replenishing developer hopper 14 that is disposed so as to feed a replenishing developer to the conveyance path. The replenishing developer hopper 14 stores a replenishing developer that comprises a replenishing toner and a replenishing carrier with a higher toner content than in the developer that is present in the developing device 4. The developing device 4 may separately include a toner hopper for a replenishing toner and a carrier hopper for a replenishing carrier so that both the replenishing toner and replenishing carrier can be fed to the developer convey path.

The developing device 4 is provided with a discharge port from which excess developer is discharged. The toner discharge method is not limited. Various toner discharge methods may be adopted, which include an overflow method in which toner is discharged by an amount corresponding to an increase in volume, a shutter method in which discharge of toner is controlled by opening a shutter, and a selective discharge method in which only degraded developer is discharged.

The developer is conveyed to the development region in accordance with rotation of the developing roller 10, and the toner develops the electrostatic latent image formed on the photoconductor body 1. The developer in which the toner content decreases is recovered into the developing device 4 in accordance with rotation of the developing roller 10. The recovered developer is separated from the developing roller 10 at the position of the release pole of the magnet roller 20 that is included in the developing roller 10. The developer is then brought by the developer stirring augers 12 and mixed with the other developer.

When it is detected that the toner content in the developer has decreased below a predetermined range, a fixed amount of developer is replenished into the developing device 4 from the supply port of the replenishing developer hopper 14. In a case where the toner and carrier are stored in different hoppers, a fixed amount of carrier, too, is replenished at a predetermined timing. An amount of developer, which corresponds to the increased volume, is discharged from the discharge port, and the amount of developer in the developing device 4 is kept substantially constant.

The developer characteristics are gradually degraded. However, if the carrier replenishing rate is adjusted, good characteristics, which are above an image quality limit level, can stably be maintained. This makes it unnecessary to perform batch-replacement of the entire developer, which would be required when the developer characteristics deteriorate below the image quality limit level. A downtime of the machine due to replacement of developer can be eliminated.

FIG. 17 is a graph showing a comparison of the developer characteristics. In FIG. 17, in the batch-replacement of developer in the prior art, the developer characteristics are degraded as indicated by line “A”. In the case of the present embodiment, the developer characteristics vary as indicated by line “B”.

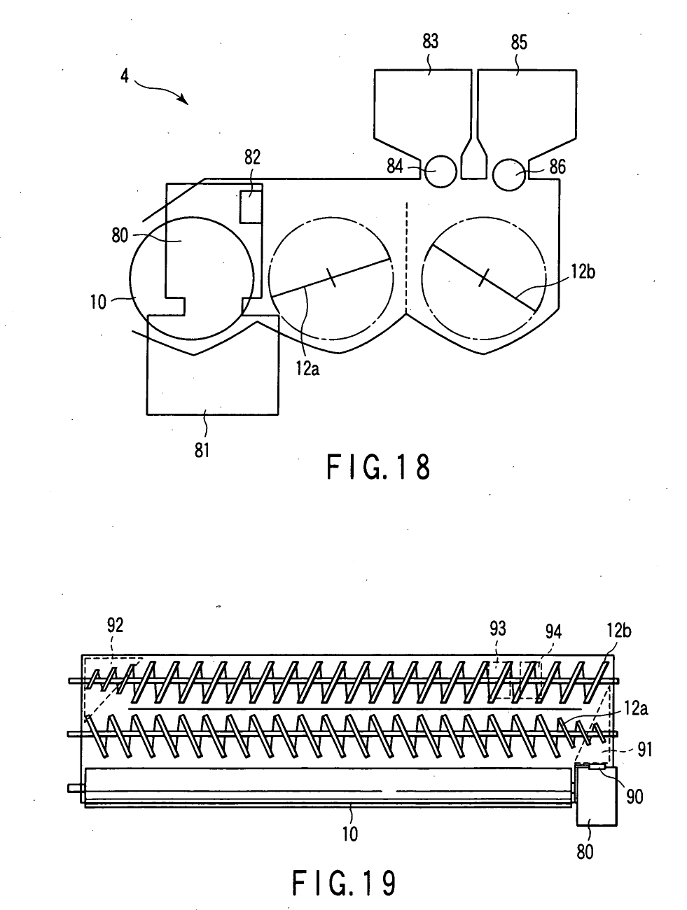

FIG. 18 and FIG. 19 show an example of the structure of the developing device 4 that adopts an occasional small-amount developer replacement method. FIG. 18 is a cross-sectional view of the occasional small-amount developer replacement type developing device 4, and FIG. 19 is a top view of the occasional small-amount developer replacement type developing device 4.

This developing device 4 separately includes a toner hopper for a replenishing toner and a carrier hopper for a replenishing carrier. The replenishing toner and replenishing carrier are supplied into the developing device 4 at predetermined timings.

In FIG. 18, the occasional small-amount developer replacement type developing device 4 comprises a developing roller 10, a first developer stirring auger 12a, a second developer stirring auger 12b, a second chamber 80, a third chamber 81 serving as a waste developer container, a discharge opening 82, a replenishing toner hopper 83, a toner replenishment control roller 84, a replenishing carrier hopper 85, and a carrier replenishment control roller 86.

In FIG. 19, the occasional small-amount developer replacement type developing device 4 includes a discharge port 90 at the second chamber 80, a raised-bottom part 91 at the first developer stirring auger 12a, and a raised-bottom part 92, a toner replenishing port 93 and a carrier replenishing port 94 at the second developer stirring auger 12b.

Using the occasional small-amount developer replacement type developing device 4, a life test was conducted under the condition that a carrier replenishment amount is 10 g per 100 g of toner consumption.

In the case of using a conventional developing roller with a substantially smooth surface, the developer conveyance performance of the developing roller gradually decreased over the life. The image density of 1.5 (Macbeth densitometer) at the initial stage decreased to 1.0 at the end of printing of 200,000 sheets.

By contrast, with the irregularities formed on the surface of the developing roller 10, the image density was successively maintained in the initial set state.

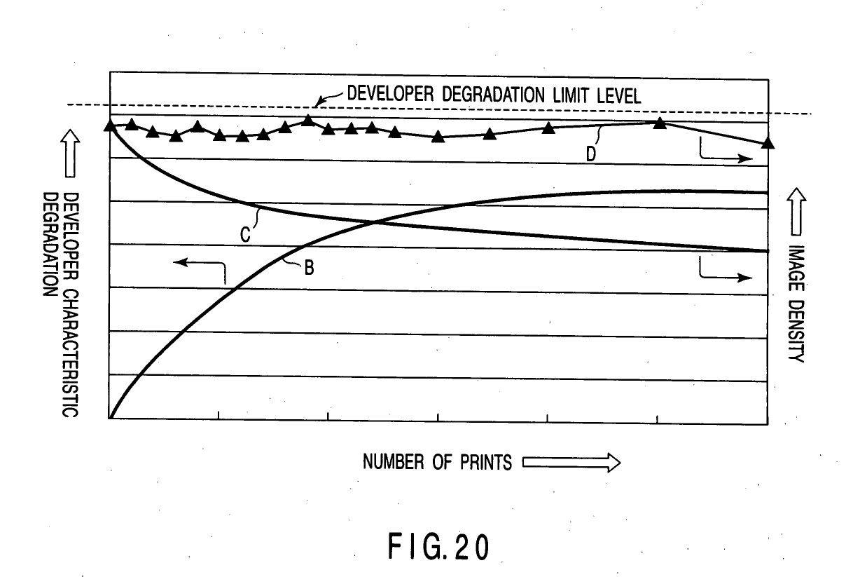

FIG. 20 shows a life state (number of prints) of image density in a case where the developing roller 10 according to the occasional small-amount developer replacement method is used. In FIG. 20, a curve B indicates the development degradation level of the present embodiment shown in FIG. 17. A curve C indicates a decrease in image density in the prior art, and a curve D indicates the image density of the present embodiment. The curve D relating to this embodiment is stable, as shown in FIG. 20.

As has been described above, the layer restriction member for restricting the conveyance amount of developer is provided. This member can adjust the thickness of the magnetic brush layer.

Next, a seventh embodiment is described.

The seventh embodiment relates to a cleanerless process that executes simultaneous development/cleaning at the development region, without using a cleaning device that recovers post-transfer residual toner on the photoconductor body 1 and discharges the recovered toner.

In this embodiment, a styrene-acryl monomer, a pigment and wax are mixed, polymerized and granulated. An external additive is added to the resultant particles. Thus, spherical polymer toner with a volume mean grain size of 6 μm is obtained. A developer is composed of 93 wt. % of carrier particles with a volume mean grain size of 40 μm, which are formed by surface-coating magnetite particles with silicone resin, and 7 wt. % of the polymer toner.

The replenishing developer hopper 14 stores a replenishing developer that contains 20 g of replenishing carrier per 100 g of toner consumption. In accordance with toner consumption, the replenishing developer is supplied. The developing device 4 lets excess developer overflow through the discharge opening 82. Thereby, the occasional small-amount developer replacement was executed.

The photoconductor body 1 is uniformly charged at −600 V by the charging device 2. The photoconductor body 1 is exposed by the exposure device 3 in accordance with an image to be formed. Thus, an electrostatic latent image is formed on the photoconductor body 1. Subsequently, an image part on the photoconductor body 1 is supplied with toner from a magnetic brush that is formed on the developing roller 10 to which a development bias of −400 V is applied. Thus, a toner image is formed. Then, the toner image on the photoconductor body 1 is transferred to the transfer medium P by the photoconductor body 1 and transfer roller 5. The developing roller 10 is subjected to the knurling process such that grooves are formed on the surface thereof in parallel to the rotational axis of the developing roller 10, with a groove depth of 200 μm, a groove width of 200 μm and a groove pitch of 300 μm.

An image structure of post-transfer residual toner on the photoconductor body 1 is disturbed by the memory disturbing brush 7 that is formed of electrically conductive fibers and supplied with a negative voltage. The photoconductor body 1 undergoes charging and exposure once again, and reaching the development region. The post-transfer residual toner that adheres to the non-image part of a newly formed electrostatic latent image is recovered into the developing device 4. The developing roller 10 of the developing device 4 rotates with a circumferential speed ratio of 2, relative to the photoconductor body 1. Thus, the post-transfer residual toner on the photoconductor body 1 is stimulated by a development electric field that minutely oscillates with 4 cycles/mm. The post-transfer residual toner is mechanically brushed by the magnetic brush, separated from the photoconductor body 1 by the electric field acting toward the developing roller 10, and restored into the developing device 4.

Preferably, the electric field oscillation cycle, which can be calculated by (circumferential speed ratio between developing roller 10 and photoconductor body 1)×(groove pitch on developing roller 10), should be 1 cycle/mm or more. The development bias may be not only DC, but also DC+AC. The structures and conditions in this invention are not limited to those described above, and other structures and conditions may be adopted without departing from the spirit of the invention.

As has been described above, according to the seventh embodiment, the developing roller surface is provided with irregularities. Thereby, the frictional resistance increases and the developer conveyance amount does not decrease. Therefore, a decrease in image density and occurrence of image memory can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus using a two-component developer that is composed of at least non-magnetic color particles and magnetic particles, the apparatus comprising:
an image carrying body that carries an electrostatic latent image on a surface thereof;
a developer carrying body that is disposed at a position facing the image carrying body, has, on a surface thereof, grooves that catches carrier particles, and develops the electrostatic latent image, which is carried on the image carrying body, using the two-component developer; and
a control unit that executes a control to move the developer carrying body and the image carrying body at different circumferential speeds,
wherein the grooves on the surface of the developer carrying body are arranged in parallel at regular intervals with an inclination of 0°±45° to a rotational axis of the developer carrying body, and
wherein d<c, where c is a width of the groove on the surface of the developer carrying body, and d is a mean grain size of the magnetic particles.

2. The image forming apparatus according to claim 1, wherein the grooves on the surface of the developer carrying body are formed by a knurling process.

3. The image forming apparatus according to claim 1, wherein the developer carrying body includes a cylindrical developer carrying roller with the grooves on a surface thereof, and a magnet roller that is included and fixed within the cylindrical developer carrying roller.

4. The image forming apparatus according to claim 3, wherein the cylindrical developer carrying roller is formed of an electrically conductive material.

5. The image forming apparatus according to claim 1, wherein the non-magnetic color particles are toner particles, and the magnetic particles are magnetic carrier particles.

6. The image forming apparatus according to claim 1, further comprising:
a container that contains the two-component developer as well as the developer carrying body;
a conveyance member that is disposed within the container and conveys the two-component developer to the developer carrying body while stirring the two-component developer;
a determination unit that determines a mixture ratio of toner particles that are the color particles in the two-component developer contained in the container;
a developer hopper that stores, separately or together, the toner particles and magnetic carrier particles that are the magnetic particles;
a replenishing mechanism that replenishes, separately or together, the toner particles and the magnetic carrier particles from the developer hopper into the container in accordance with a determination result of the determination unit; and
a discharge unit that discharges a predetermined amount of developer from the container.

7. The image forming apparatus according to claim 1, wherein the grooves increase efficiency of recovery from post-transfer residual toner to the developer carrying body.

8. A color image forming apparatus using a two-component developer that is composed of at least non-magnetic toner particles and magnetic particles, the apparatus comprising:
a plurality of image forming units, each of which includes,
an image carrying member that carries an electrostatic latent image on a surface thereof,
a developer carrying member that has, on a surface thereof, grooves that catches carrier particles, is disposed at a position facing the image carrying member, develops the electrostatic latent image which is carried on the image carrying member using the two-component developer, and recovers post-transfer residual toner on the image carrying body, and
a transfer unit that transfers a toner image, which is developed on the image carrying body by the developer carrying body; and
a control unit that executes a control to move the developer carrying body and the image carrying body at different circumferential speeds.

9. The color image forming apparatus according to claim 8, wherein said plurality of image forming units are arranged along a convey path for conveying a transfer medium, to which the toner image on each of the image carrying bodies is transferred by the associated transfer unit.

10. The color image forming apparatus according to claim 8, wherein the color image forming apparatus comprises four said image forming units that form toner images of four colors of cyan, magenta, yellow and black.

11. The color image forming apparatus according to claim 8, wherein the grooves increase efficiency of recovery from post-transfer residual toner to the developer carrying body.

12. An image forming apparatus using a two-component developer that is composed of at least non-magnetic color particles and magnetic particles, the apparatus comprising:
means for carrying an electrostatic latent image;
means for developing the electrostatic latent image on the carrying means, using the two-component developer, the developing means being disposed at a position facing the carrying means and having, on a surface thereof, grooves that catches carrier particles; and
means for controlling a circumferential speed of the developing means and a circumferential speed of the carrying means relative to each other.

13. A color image forming apparatus using a two-component developer that is composed of at least non-magnetic toner particles and magnetic particles, the apparatus comprising:
a plurality of image forming means, each of which includes,
means for carrying an electrostatic latent image,
means, disposed at a position facing the carrying means and having, on a surface thereof, grooves that catches carrier particles, for developing the electrostatic latent image on the carrying means, using the two-component developer, and for recovering post-transfer residual toner on the carrying means, and
means for transferring a toner image on the carrying means developed by the developing means; and
means for controlling a circumferential speed of the developing means and a circumferential speed of the carrying means relative to each other.

14. The color image forming apparatus according to claim 13, wherein the grooves increase efficiency of recovery from post-transfer residual toner to the developer carrying body.

15. A method for forming an image forming apparatus using a two-component developer that is composed of at least non-magnetic color particles and magnetic particles, the method comprising:
making an electrostatic latent image;
developing the electrostatic latent image with the two-component developer with a grooved developer conveying member that catches carrier particles; and
controlling a moving speed of making the electrostatics latent image and a developing speed by developer conveying speed relative to each other.

16. The method for forming an image according to claim 15, further comprising:
transferring the developed electrostatic latent image by the developing with the developer onto a transferring member; and
recovering a residual of the developer after transferring.

17. The method for forming an image according to claim 15, wherein the grooved developer conveying member increases efficiency of recovery from post-transfer residual toner to the developer carrying body.
